(19) United States
(12) Patent Application Publication
(10) Pub. No.: US 2008/0015916 A1
(43) Pub. Date: Jan. 17, 2008

(54) USING CONFIGURABLE PROGRAMMATIC RULES FOR AUTOMATICALLY CHANGING A TRUST STATUS OF CANDIDATES CONTAINED IN A PRIVATE BUSINESS REGISTRY

(75) Inventors: BRENT W. COSSEY, ROANOKE, TX (US); GREGORY P. FITZPATRICK, KELLER, TX (US); ROBERT S. KELLER, COLLEYVILLE, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/860,082

(22) Filed: Sep. 24, 2007

Related U.S. Application Data
(63) Continuation-in-part of application No. 10/153,084, filed on May 22, 2002, now abandoned.

(51) Int. Cl. G06Q 10/00; G06F 17/30; G06F 17/40

(52) U.S. Cl. 705/7

(57) ABSTRACT

The present invention discloses a solution for a private business registry that includes trust status attributes that automatically change based upon business events in accordance with a set of configurable rules. The programmatic service for adjusting trust status attributes can remain resident on a server that manages the private business registry and can monitor activity that constitutes a variety of business processes as described in the services profile. The profile can and must be customized by a target enterprise. When business transactions occur between the target enterprise and one or more candidate enterprises (e.g., seeking enterprises) wishing to conduct business with the target enterprise, the resident service can compare transaction specifics against a ruleset contained in the profile. When the occurrence of the event causes a threshold to be met (via ruleset execution) the resident service can then change a value of the trust status attribute of a seeking entity.

### CROSS-REFERENCE TO RELATED APPLICATIONS

This continuation-in-part application claims the benefit of U.S. patent application Ser. No. 10/153,084 filed May 22, 2002, which is incorporated by reference herein.

### BACKGROUND

1. Field of the Invention

The present invention relates to the field of business registries and, more particularly, to using configurable programmatic rules for automatically changing a trust status of candidates contained in a private business registry.

2. Description of the Related Art

Businesses often use business registries (BR's) to advertise their offering to potential customers. Business registry entries include searchable information concerning the services and the provider of these services. Some business registries support standards the permit direct computer to computer interactions. For example, Universal Description, Discovery and Integration (UDDI), which is an Organization for the Advancement of Structured Information Standards (OASIS) standard, is a platform-independent, XML based registry that uses open standards that define how services or software applications interact over the Internet. More specifically, the UDDI specification and protocol work together to form define messages, application programming interfaces (APIs), and data structures for building distributed registries of Web services and storing the business and technical information associated with these services. A UDDI registry typically contains metadata for a service embodied within a Web service Description Language (WSDL) document.

There are fundamentally two types of business registries: public registries and private registries. Public registries are accessible by anyone and can be considered part of a Universal Business Registry (UBR). A private registry is an instance of business registry that is access restricted (i.e., is not part of a UBR cloud). A private instance need not be accessible only to a specific individual or organization. It is instead possible to share a registry instance among a set of like-minded entities that come together for a specific purpose. For example, a company (e.g., target enterprise) and all its suppliers (e.g., seeking entities) can use a private registry to exchange information.

That is, a private business registry can be maintained for a target enterprise and can include entries for multiple candidates or seeking entities. A seeking entity is an entity desiring to do business with the target enterprise. Different levels of trust can exist between target enterprises and candidates, where the trust levels can change over time as business events occur. A trust level for the target enterprises can be maintained in the private business registry.

### SUMMARY OF THE INVENTION

The present invention discloses a solution for a private business registry that includes trust status attributes that automatically change based upon business events in accordance with a set of configurable rules. The programmatic service for adjusting trust status attributes can remain resident on a server that manages the private business registry and can monitor activity that constitutes a variety of business processes as described in the services profile. The profile can and must be customized by each owning enterprise, where an owning enterprise is a target enterprise that owns the private business registry. When business transactions occur between the target enterprise and one or more candidate enterprises (referred to as seeking enterprises) wishing to conduct business with the target enterprise, the resident service can compare transaction specifics against a ruleset contained in the profile. When the occurrence of the event causes a threshold to be met (via ruleset execution) the resident service can then change a value of the trust status attribute of a seeking entity.

For example, an owning enterprise's ruleset can specify that when a given seeking enterprise is sent three separate Requests For Proposals (RFP)'s then that record should be provided from a provisional to a trusted status. In one embodiment, the solution can modify existing publish APIs commands, such as save_business( ), to cause the modified command to promote/demote a trust status of the seeking enterprise. Similarly, when a seeking entity fails to satisfactorily conduct one or more business transactions (e.g., is over budget, schedule, etc.) then the seeking entity can be demoted from a trusted status to an untrusted status. Rules established for promoting/demoting a trust status of a seeking entity can be of arbitrary complexity. Further, any number of levels of trust can be established for seeking entities. Trust level established for the different seeking entities can be important since the target enterprise can limit opportunities for business ventures based upon the trust level. For instance, extremely important or expensive business transactions can require a higher trust level than more routine business transactions.

In various embodiments, the disclosed solution can enable the target enterprise to: a) reliably search the registry and select as candidates seeking entities meeting predetermined criteria of trustworthiness; b) assign numerical ratings to all entries reflecting their levels of trustworthiness relative to functions and/or positions currently being evaluated; c) allow for automatic promotion and demotion of assigned ratings based on criteria set by the target enterprise; and d) allow the target enterprise to modify the criteria for promotion and demotion at any time.

In one implementation, new seeking entities can be entered in a business registry with a provisional trust rating denoting a minimal level of trustworthiness for the business purpose of the respective business registry. The entry, and its associated seeking entity, can be kept at the provisional trust level until the respective seeking entity has met criteria set by the target enterprise. The criteria can include, for example, tests of legitimacy, business ethics, reliability, etc. When an entity passes these tests, it can be promoted to a higher level of trust by raising the rating of its business registry entry.

This promotion may be automatic, in the sense that it need not require an immediate interaction between the computer system managing the business registry file and a representative of the target enterprise. Criteria of these tests are subject to modification by the target enterprise at any time. Thus, depending upon the sensitivity of ventures associated with the business purpose of a business registry, the criteria may be varied. The severity of the tests can be increased as associated ventures become more sensitive and can be decreased in their severity as the sensitivity decreases. The criteria may include numerical factors representing event thresholds as well as rules applicable in a logical context for qualifying promotion of a seeking entity. Such factors and rules may also be applied in a negative context for determining conditions under which the entry of a trusted seeking entity could be demoted to a lower level of trust.

In practice, a search in a business registry may evaluate entries assigned to various levels of trust, including entries having provisional trust ratings. As noted earlier, each newly entered entry is assigned a provisional rating. A provisional rating can be a lowest rating, or an untrusted rating can be established for seeking entities that the target enterprises does not want to consider for any business transactions. Depending upon the business purpose under consideration, the target enterprise may choose to consider either all entries in a business repository or only entries having trust ratings higher than provisional. For example, if the business objective is to locate potential suppliers of a specific commodity or service, the target enterprise may exclude consideration of provisional entries and allow dissemination of Requests for Proposal (RFP's) only to enterprises having entries assigned to a highest trust level. On the other hand, if the objective involves a low-risk function (e.g. preliminary negotiations for certain, non-essential services), the target enterprise may choose to review provisional entries, and thereafter consider promotion of respective entries to status higher than provisional, conditional upon the associated entry meeting an acceptance threshold (or set of rules) set by the target enterprise.

In use, the solution can be implemented in a system that monitors business activities of the target enterprise and communications from candidate entities having entries in the business registry. Upon events determined by the target enterprise, the system can evaluate entries of entities associated with the events. Results of such evaluations can be used to selectively promote and demote trust ratings assigned to respective entries. Criteria applied to such actions may have arbitrary levels of complexity, depending upon requirements set by the target enterprise, and also may be varied by or for the target enterprise at any time. Promotion/demotion actions may be applied either automatically, by the computer system managing the business repository, or manually by representatives of the target enterprise.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for a business registry that includes trust status attributes that automatically change based upon business events in accordance with a set of configurable rules.

FIG. 2 shows entries assigned to two lists associated with two levels of trust ratings stored in a business registry in accordance with an embodiment of the inventive arrangements disclosed herein.

FIG. 3 illustrates one possible logical organization for records of a business repository.

FIG. 4 illustrates an interface for enabling the target enterprise to establish and modify criteria for upgrading and downgrading trust status values of a business registry.

FIG. 5 illustrates a diagram for evaluating business entries in a business registry.

FIG. 6 illustrates a flowchart for changing trust status values stored in a business registry based upon business transactions conducted between a target enterprise and a seeking entity.

### DETAILED DESCRIPTION OF THE INVENTION

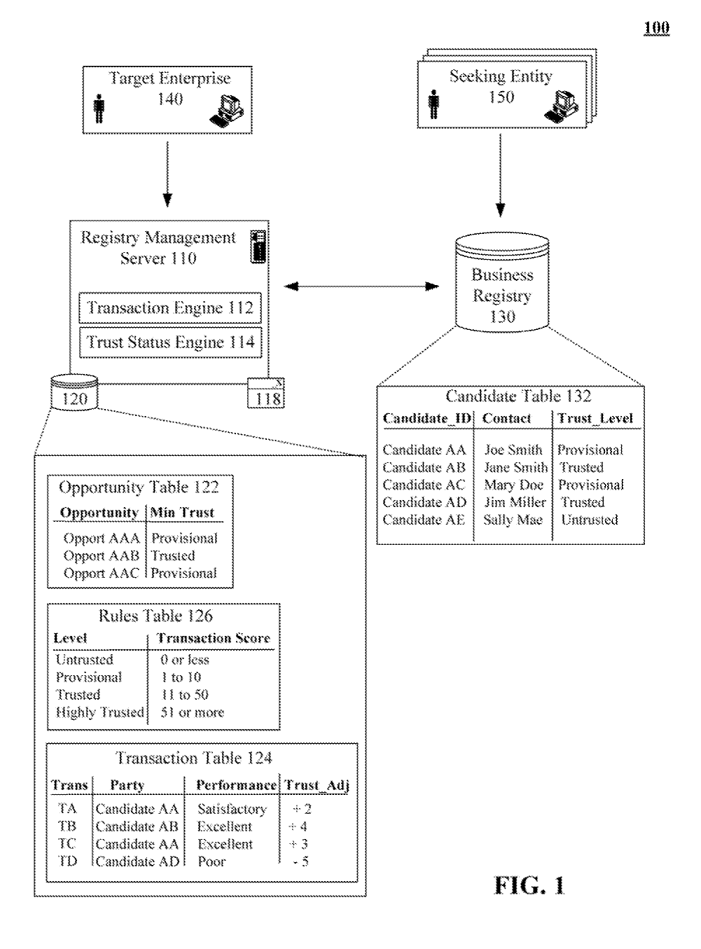

FIG. 1 is a schematic diagram of a system 100 for a business registry 130 that includes trust status attributes that automatically change based upon business events in accordance with a set of configurable rules. The business registry 130 can be a private registry that a target enterprise 140 controls. Seeking entities 150 desiring to conduct business transactions with the target enterprise 140 can have associated records included in the business registry 130. A registry management server 110 can interact with the business registry 130.

The registry management server 110 can include a transaction engine 112 that manages information concerning transactions between the target enterprise 140 and the seeking entities 150. The server 110 can also include a trust status engine 114 for changing the trust level of business registry 130 entries based upon a set of configurable rules, which can be established through configuration interface 118. The registry management server 110 can access a data store 120, which maintains data concerning business transactions associated with the target enterprise 140. For example, the data store 120 can include an opportunity table 122, a transaction table 124, a rules table 126, and the like.

The target enterprise 140 can limit business opportunities available to seeking entities 150 based upon a trust level of the seeking entity 150. For instance, table 122 shows three business opportunities each having a minimum trust level associated. As shown, Opport AAA and Opport AAC are available for seeking entities 150 having a provisional trust level or greater. Based on table 132, Candidates AA, AB, AC, and AD can be considered for Opport AAA and Opport AAC. Candidate AE is untrusted and is not able to be considered for any business transactions with the target enterprise 140. Table 122 shows that Opport AAB requires candidates to be trusted, which would include Candidate AB and Candidate AD from table 132.

As business transactions are conducted, the transaction engine 112 can process the transactions and store transactions specific records, such as records contained in transaction table 124. Each business transaction conducted with a candidate or seeking entity 150 can cause an associated trust score to be adjusted. For example, table 124 shows that Candidate AA performed satisfactory for Transaction TA, which resulted in a trust adjustment of plus two. In Transaction TB, Candidate AB performed excellently, which resulted in a trust adjustment of plus four. Candidate AA performed excellently in Transaction TC, which results in a trust adjustment of plus three. This illustrates that different transactions can have different importance levels (not shown) or weights associated so that performing excellently on two different transactions (Transaction TB and TC for example) can result in different trust score adjustments. Transactions can also lower trust scores, as shown by Transaction TD, where poor performance of Candidate AE results in a trust score adjustment of negative five.

The trust status engine 114 can establish a set of trust levels, which are to be associated with seeking entities in the business registry 130, as shown by table 126. Levels shown in table 126 include untrusted, provisional, trusted, and highly trusted. Each level can be associated with a range of trust scores. A default trust score, such as a score of 3 can be assigned to new seeking entities 150. Thus, untrusted entities can be those that were given an opportunity to conduct business with the target enterprise 140 and who performed poorly, such as Candidate AE did in Transaction TD of table 124.

An authorized agent of the target enterprise 140 can use interface 118 to configure behavior and thresholds that engines 112 and 114 are to follow. For example, interface 118 can be used to specify criteria for whether a candidate's performance is satisfactory, excellent, or poor. Criteria can be based on quantitative factors managed by server 110, such as a completion time for a transaction, a cost of a transaction, a quality of a transaction, and the like. Rules used by the server can be of arbitrary complexity. It should be appreciated that example data values and table structures shown in system 100 were provided for illustrative purposes only and are not to be construed as a limitation upon the disclosed invention.

As used herein, the business registry 130 can be a searchable information repository containing information concerning a set of services desired by a target enterprise 140 and a set of services provided by one or more seeking entities 150. The business registry 130 can be a private registry controlled by target enterprise 140. In one implementation, the business registry 130 can be an Universal Description, Discovery and Integration (UDDI) compliant registry. UDDI is a platform-independent, XML based registry that uses open standards that define how services or software applications interact over the Internet. More specifically, the UDDI specification and protocol work together to form define messages, application programming interfaces (APIs), and data structures for building distributed registries of Web services and storing the business and technical information associated with these services. A UDDI registry typically contains metadata for a service embodied within a Web service Description Language (WSDL) document. The UDDI is a Organization for the Advancement of Structured Information Standards (OASIS) maintained standard. Further, seeking entities 150 can be permitted to submit WSDL formatted information directly to the registry 130. The target enterprise 140 can also interact with entries of the registry using WSDL formatted messages. When the business transactions of the target enterprise 140 involve Web services, the registry 130 can specify how to interact with the Web services provided by the seeking entity 150, such as through using a SOAP based standard.

Data store 120 and business registry 130 can be physically implemented within any type of hardware including, but not limited to, a magnetic disk, an optical disk, a semiconductor memory, a digitally encoded plastic memory, a holographic memory, or any other recording medium. A data store 120 or 130 can be stand-alone storage unit as well as a storage unit formed from a plurality of physical devices, which may be remotely located from one another. Additionally, information can be stored within a data store 120 or 130 in a variety of manners. For example, information, such as tables 122-126 and 132, can be stored within a database structure or can be stored within one or more files of a file storage system, where each file may or may not be indexed for information searching purposes. The data stores 120 or 130 can be optionally encrypted for security reasons.

The components shown in system 100 (server 100, registry 130, enterprise 140, entity 150) can exchange information with each other over a network (not shown). The network can include components capable of conveying digital content encoded within carrier waves. The content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

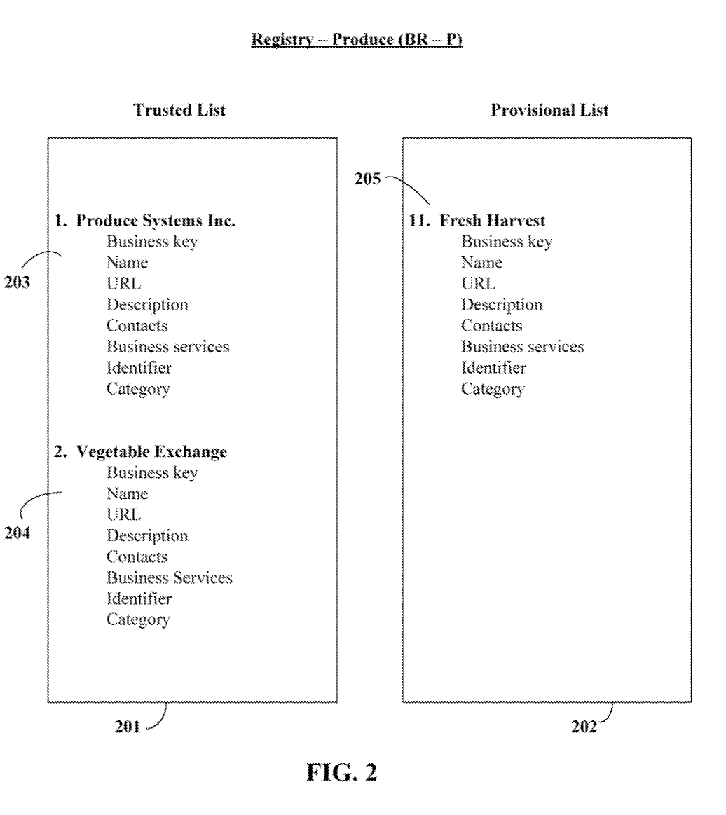

FIG. 2 schematically illustrates an example of a business registry ‘BR-P’ associated with produce (fruits, vegetables, etc.). FIG. 2 can be performed in a context of system 100 or any other system where a business registry maintains trust values for business candidates that are situationally adjusted based upon prior candidate performance.

FIG. 2 shows entries assigned to two lists associated with two levels of trust ratings; a trusted list 201 and a provisional (least trusted) list 202. However, although only two such lists are illustrated, it will be understood that additional lists may be used to associate with entries having trust ratings intermediate those of lists 201 and 202.

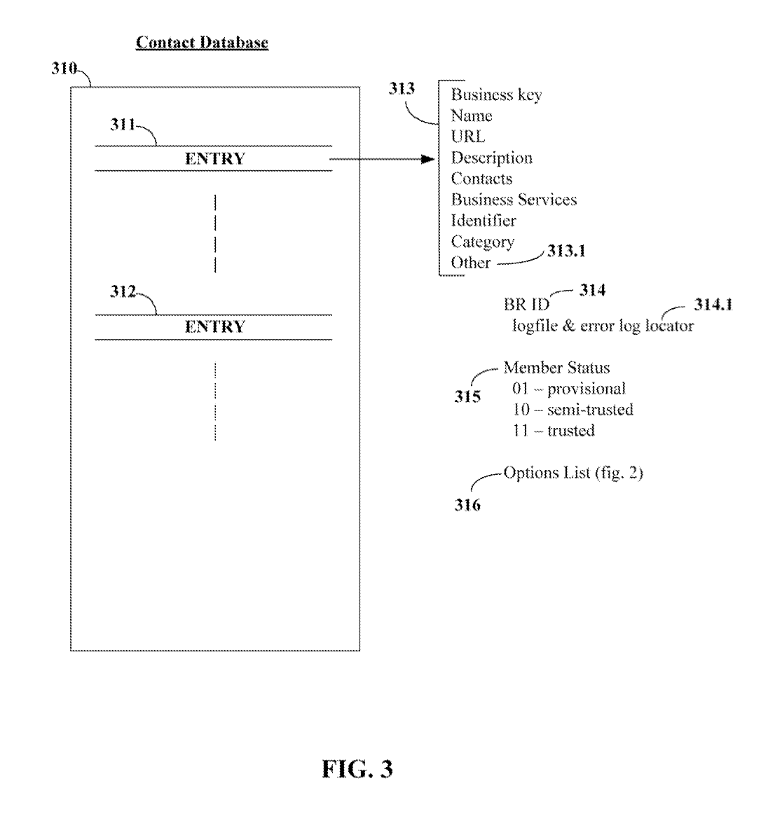

In the illustrated example, trusted list 201 contains two entrics—‘Produce Systems Inc’ and ‘Vegetable Exchange’, shown respectively at 203 and 204—and provisional list 202 contains a single entry, ‘Fresh Harvest’ shown at 205. Each entry can be a standard entry of a registry, such as a UDDI compliant registry. As such, each BR entry can include a number of information parameters. Some of these are shown in FIG. 2, and others, including trust ratings and criteria for their assignment and modification, as shown in FIG. 3.

Parameters shown in FIG. 2 can include a Business Key, a Name, a URL, a Description, a Contacts entry, a Business Services entry, an Identifier, a Category, and the like. The Business Key can be a number uniquely identifying the respective seeking entity. The Name can be a name of respective entity (e.g. company name or ‘doing business as’ name, etc.). The URL can be a Universal Resource Locator (website address) of respective entity. The Description can be a brief description of respective entity and its capabilities. The Contacts entry can specify main points of contact at entity (address, phone number, key employees, etc.). Business Services can detail business service(s) provided by respective entity. These services can include Web services and Web service details. The Identifier can be a number uniquely identifying business area of respective entity. The Category can include a type of industry/business in which respective entity operates.

The information entries shown in lists 201 and 202 can be organized in a database. Although it is convenient for descriptive purposes to show two different lists for two different levels of trust, a typical implementation would include a database attribute for a trust level, where each seeking entity (e.g., candidate) would have a characteristic value for the trust level. Using a database attribute permits an arbitrary level of trust values to be established and used, where use of separate lists would become somewhat cumbersome as a number of trust levels changed.

FIG. 3 illustrates one possible logical organization 310 of a possible seeking entities (e.g., candidates for conducting business transactions with a target enterprise) within records of a business repository, such as repository 130 of system 100. FIG. 3 shows how fields for a trust status 315 can be integrated into an “other” 313.1 field of repository entries, such as UDDI entries maintained in a private UDDI business repository. Consecutive entries are shown at 311 and 312. Exemplary information parameters for entry 311, shown at 313, 313.1, and 314-316, are also representative of corresponding parameters in all other entries.

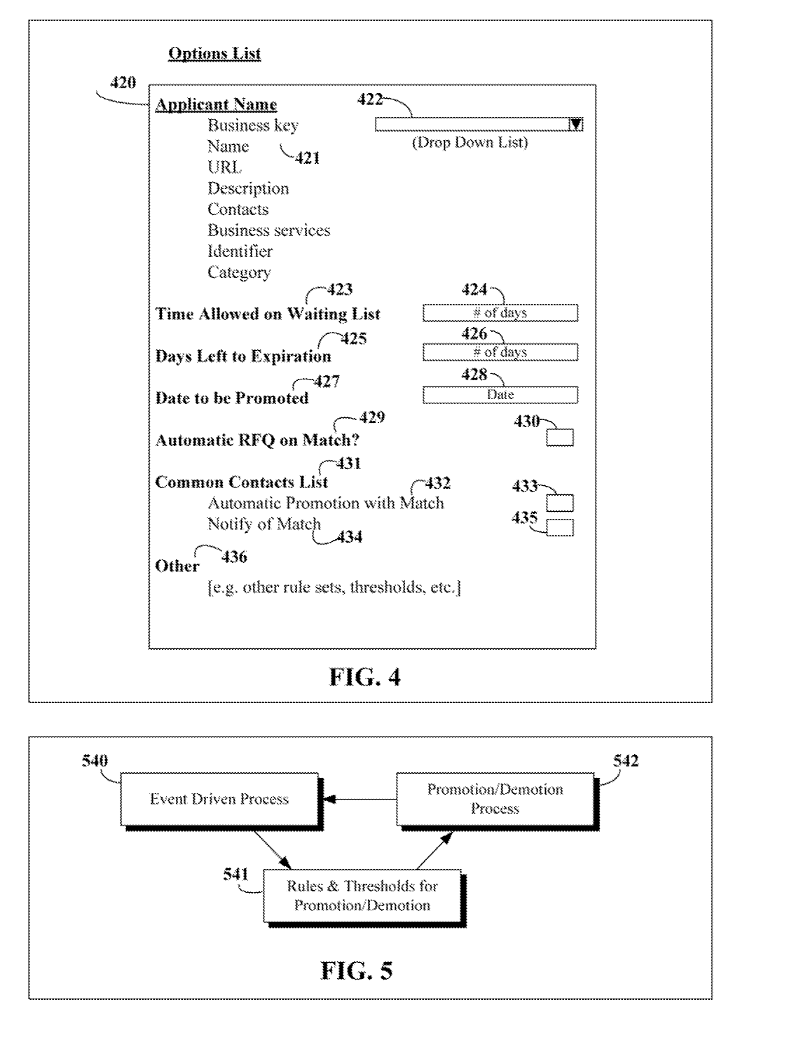

As seen at 313, in addition to the parameters shown in FIG. 2, parameters 313 of entry 311 include function 313.1, designated ‘other’ which is associated with other parameters that are more specifically relevant to the present invention. Each entry has ‘other’ information entry corresponding to that shown at 313.1. Specific examples of such ‘other’ information are shown at 314, 315 and 316. It will be understood, from the description of FIG. 4 to follow, that these are representative examples, and that a business repository as presently contemplated may have other information not specifically shown in either FIG. 2 or FIG. 3. That is, the arrangements shown in FIGS. 2 and 3 are for illustrative purposes only and the invention is not to be construed as limited in this regard.

The example of ‘other’ information at 314 is a identifier number, ‘BR ID’, unique to the respective business repository. As suggested at 314.1, this number serves as a link for locating a logfile and an error log file which are associated with the respective BR and contain logged information pertaining to processing of individual entries.

The ‘other’ information at 315 consists of a member status number defining the respective entry's trust rating. In the illustrated example, this number is a two digit binary value denoting that rating as one of: ‘provisional’ (value ‘01’ in the example), ‘trusted’ (value ‘11’ in the example), and ‘semi-trusted’ (value ‘10). Member status information 315 of all repository entries is useful to enable the target enterprise to extract the provisional and trusted lists of FIG. 2, as well as lists pertaining to levels of trust intermediate provisional and fully trusted. Those skilled in the database arts understand that extraction of such lists would involve execution of presently conventional database search operations.

Other significance and potential uses of member status information 315 is as follows. Entities whose entries have ‘provisional’ status may add basic information 313 to the repository (or have such information added by the target enterprise), do not have access to ‘other’ information 313.1, and generally would not be subject to immediate consideration for a business relationship involving trust. Entities having ‘trusted’ status are those which have met criteria established by the target enterprise relative to business purposes of the respective business repository, and are considered eligible to participate as a trusted business partner or associate in any venture associated with the respective business repository. Entities having ‘semi-trusted’ status are entitled to more favorable consideration than those having provisional status and less favorable consideration than those with trusted status.

As noted earlier, as an entry is placed initially into a business repository it is assigned provisional status, and is subject to promotion to more trusted status only when it has passed tests of trustworthiness defined by the target enterprise, criteria for which are subject to modification at any time by the target enterprise (refer to descriptions of FIGS. 4-6 to follow).

The ‘other’ information example at 316 includes information associated with the trust test criteria mentioned above. This includes information in and locators for the Options list of FIG. 4. That list effectively contains criteria determining events at which an entry may be evaluated for promotion and demotion, and rules and thresholds defining conditions under which an entry could actually be promoted or demoted (i.e. have its member status respectively increased or decreased in ‘trust’ value). As noted earlier, such promotion may be either automatic or via manual intervention of the target enterprise.

FIG. 4 illustrates an options list for enabling the target enterprise to establish and modify criteria for upgrading and downgrading ‘member status’ values 315 of individual entries. Entries in this list having ‘provisional status’ relative to an associated business repository are effectively on a ‘waiting list’ relative to that business repository, and entries having ‘trusted’ status relative to the same business repository are effectively on a ‘trusted list’ for the respective business repository. Thus, the options list effectively enables the target enterprise to establish criteria for promoting entries from the waiting list to the trusted list and demoting entries from the trusted list to the waiting list. It is important to understand that parameters illustrated in FIG. 4 are intended to serve as examples of what a target enterprise might include on their options list, and that many other parameters may be used by different target enterprises to establish their criteria for promotion/demotion.

In one embodiment, interface 420 shown in FIG. 4 can be used by an authorized agent of a target enterprise to modify parameters for increasing/decreasing trust levels of seeking entities. For example, interface 420 can be one contemplated embodiment of interface 118 of system 100. Interface 420 shows initially blank entries at 421 corresponding to those shown at 313 in FIG. 3 (i.e. business key, name, URL, etc.). A drop-down list at 422 contains names of seeking entities having entries in the associated business repository. These names may be associated with all entries in the repository, or they can be restricted by the target enterprise to those associated with specific lists; i.e. the provisional list, trusted list, etc. Upon selection of a name from list 422, entries 421 are filled in with database information associated with the respective name and business repository; i.e. information as shown at 313, FIG. 3.

The options list also contains spaces 423-435, containing headings and spaces that are initially blank when the list is accessed. The headings are fixed for all accesses to the options list and the initially blank spaces contain information which is extracted from the business repository database when an entry name is selected from list 422. The information in all of these spaces 423-435 is associated with criteria relevant to promotion and demotion of member status ratings. This information is set initially into the database by the target enterprise (or authorized representative), and it may be modified by the target enterprise at any time during existence of the business repository. Some of the information in these spaces (both headings and other spaces) also may be automatically modified during system access to the Options List for evaluating trust ratings of individual business repository entries.

Heading 423, ‘Time Allowed on Waiting List’, can be associated with input element 424. Element 424 can indicate a number of days a respective entry, if on a ‘waiting list’ in the associated business repository, can be allowed to remain on that list. Heading 425, ‘Days Left to Expiration’, can be associated with input element 426. Element 426 indicates a number of days remaining until the respective entry expires as a waiting list entry for the BR. Heading 427, ‘Date to be Promoted’, can be associated with input element 428. Element 428 can indicating a date on which the respective entry, if on a waiting list must be expelled from that list, and provisionally promoted to another list. Heading 429, ‘Automatic RFQ on Match, can be associated with input element 430 containing a criterion (supplied by the target enterprise) for determining conditions under which a request for price quotation (‘RFQ’) may be automatically sent to and solicited from a respective seeking entity during normal system access to the respective entry.

Heading 431, ‘Common Contacts List’, can be associated with sub-headings 432 and 433. Sub-heading 432, ‘Automatic Promotion With Match’, can be associated with input element 433, the latter containing criteria (set by the target enterprise) for automatic promotion of the respective seeking entity to the associated trusted list if that entity is currently on a respective waiting list (see item 428 above). Sub-heading 434, ‘Notify of Match’, can be associated with input element 435 containing criteria (set by the target enterprise) indicating if a contact for the respective seeking entity should or should not be notified of a promotional change in status for that entity. Heading ‘other’ at 436 refers to not-shown other information pertaining to promotion and demotion. It should be understood that some of this other information can be devoted to specifying conditions for expulsion of entries from an associated business repository trusted list and/or criteria for demoting existing entries from trusted status to lesser status.

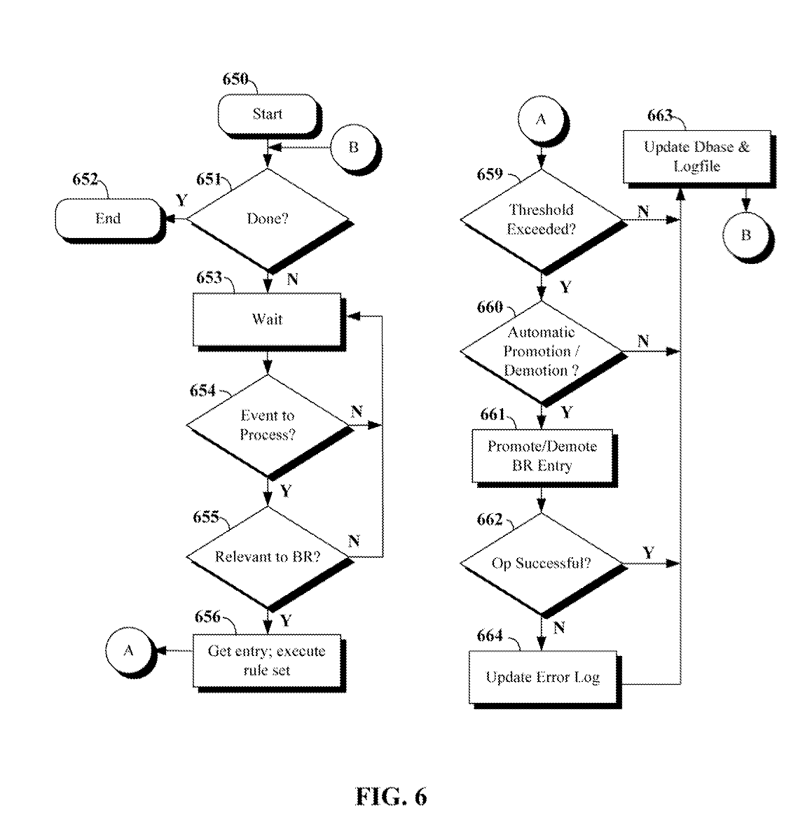

FIG. 5 contains a flowchart for explaining processes of operation in the subject system/service for evaluating business repository entries in respect to promotion and demotion of their trust (member status) ratings. FIG. 6 shows a flowchart for explaining details of processes suggested in general terms in FIG. 5. Where applicable, in the discussion of FIG. 6, the use of the Options List and other elements of the business repository database will be explained. However, it should be understood that the Options List and other elements are also subject to access by the target enterprise when entries are not being evaluated.

FIG. 5 illustrates general elements of a process for evaluating member status ratings for promotion and/or demotion. The process includes three process elements; an ‘event driven’ element 540, an element 541 for examining rules and other criteria and applying them to individual business repository entries, and an element 542 for selectively promoting and/or demoting member status ratings based on results of executing element 541. Event driven process element 540 detects occurrence of events specifically relevant to the business repository and its entries; see e.g. items 423-436 FIG. 4.

Details of these process elements are shown in FIG. 6. Details of event driven processing are indicated at 650-655, details of rules and threshold examination are shown 656-660, and details of promotion/demotion processing are shown at 661-664. At the start 650 of event driven process execution, the system maintaining the business repository for the target enterprise determines, at 651, if all business repository entries potentially affected by prior occurrence of a relevant event have been evaluated. If all such evaluations have been executed the process ends at 652. However, if the evaluations have not been started or completed, the system enters a waiting loop 653-655 of indefinite duration, during which it waits to detect occurrence of an event (or events) relevant to promotion and/or demotion of business repository trust status ratings.

When such event(s) is/are detected actions 656 are taken to fetch a repository entry and evaluate a rule set which specifies conditions under which the member status rating of that entry could be eligible for promotion or demotion. Among those conditions are one or more thresholds associated with the rule set. Relevant rule sets are suggested by entries in the options list of FIG. 4. An example of another relevant rule not suggested in FIG. 4 could, for example, be on that conditions promotion of an entry having provisional status to trusted status if and only if the respective entity has responded to three RFQ's. An associated threshold in this example would be the number 3 associated with the required number of RFQ responses.

Following operations 656, the system links (via process connectors indicated by circular symbol A) to decision 659 at which a determination is made as to whether or not a threshold has been exceeded (or thresholds have been exceeded) at which the respective entry's member status rating should be considered for promotion or demotion. It should be understood that this determination involves consideration of both the threshold occurrence and the immediate value of the respective member status rating; i.e. if the current value is a highest trust level obviously it would not be considered for promotion, and if the current value is at a provisional level it would not be considered for demotion.

If relevant threshold has not been exceeded, or the entry status is otherwise ineligible for promotion or demotion, steps 663 are executed to update the system database and logfile relative to the entry, and the system returns to initial processing step 651 via connections indicated by circular symbols B.

If the foregoing threshold has been exceeded, and it is one pertinent to promotion of the member status rating of the entry currently being evaluated, the system decides at 660 if the respective member status rating is subject to automatic promotion (as distinct from non-automatic handling via manual intervention of a representative of the target enterprise). If the entry is not subject to automatic promotion, operations 663 are executed, to update the system database and logfile, and the process returns to initial step 651 as noted previously. If results of decisions 659 and 660, are both positive, the member status rating of the respective business repository entry is promoted to a higher trust status (step 661) and if that operation is executed successfully (positive result at decision 662), the system updates relevant entry parameters in the database and logfile (operations 663) and returns to the initial operation 651 in the manner previously noted. If the promotion process is not successfully executed, appropriate entries are made in the system's error log (step 664) and database and logfile (steps 663), and the system returns to initial operation 651.

Upon return to initial step 651, the system determines at 651 if all business repository entries affected by the previously detected event have been processed. If they have not, the system passes directly through the wait loop 653-655 to fetch another entry and evaluate its member status in respect to that event. Thus, the process continues until all entries affected by an event have been evaluated and member status ratings have been selectively modified where applicable. When all entries have been processed, the process ends at 652, and later restarts at 650 after an appropriate time has passed

It is noted that decision 660 and action 661 refer both to promotion and demotion of entry status. With respect to demotion, it should be understood that the threshold considered at decision 659 has a negative context reflecting conditions under which an entry currently having trusted status could be eligible for demotion to less trusted or even provisional status.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A software application for managing business transactions on behalf of a target business enterprise, said software application comprising:
software for adding, editing, and deleting entries maintained within a business repository, said business repository having information entries descriptive of business entities that are candidates for future business transactions with a target enterprise; the information for each said entry including a trust status value denoting a level of trust instantly assigned to the respective candidate entity;
a list containing information including logical criteria for selectively increasing values of individual ones of said trust status values in said business repository so as to effectively promote respective candidate entries to higher levels of trust consideration;
a set of programmatic instructions stored in a machine readable medium capable of being executed by a machine to cause the machine to utilize said list to evaluate said information entries in said business repository to determine if trust status values of respective entries are worthy of being increased and responsive to said evaluations to selectively increase values of trust status values of entries determined to be worthy of a higher level of trust consideration.

2. The software application of claim 1, wherein said set of programmatic instructions providing restrictive access to said list for enabling said logical criteria to be established and modified exclusively in behalf of said target enterprise.

3. The software application of claim 1, wherein the business repository is a private instance of a Universal Description, Discovery and Integration (UDDI) complaint business registry to which the target enterprise controls access.

4. The software application of claim 3, wherein said business entities are able to add entries to the business registry using Web Service Description Language (WSDL) based format, wherein a newly added entry is automatically assigned a default value for the trust status value.

5. The software application of claim 1, wherein the software application executes on a registry management server, which records business transactions for the target enterprise, wherein the logical criteria is based upon conditions relating to the business transactions recorded by the registry management server.

6. The software application of claim 1, wherein human agents of the target enterprise are authorized to dynamically change a condition data set upon which the logical criteria makes deterministic decisions, wherein changing the condition data set results in values of the member trust status stored within the business repository changing.

7. The software application of claim 1, wherein human agents of each of the business entities are authorized to add an entry associated with the business entity to the business registry, wherein a newly added entry is automatically assigned a default value for the trust status value, wherein interactions between the business entity and the target enterprise as recorded in business transaction data stores of the target enterprise causes the default value to automatically change in accordance with the programmatic instructions.

8. A method for adjusting a trust status of business registry entries comprising:
identifying a business transaction between a target enterprise and a seeking enterprise;
quantifying a relative success of the business transaction;
adjusting a database maintained trust parameter associated with the seeking enterprise based on the quantified success of the business transaction;
querying a private business repository for a trust level of the seeking enterprise;
utilizing a set of previously established programmatic rules to determine that the trust level is to change to a new value based on the adjusted trust parameter; and
changing the trust level of the seeking enterprise to the new value, wherein a value of the trust level that a seeking enterprise has within the private business registry determines a set of business opportunities involving the target enterprise that the associated seeking entity is qualified to handle.

9. The method of claim 8, wherein the private business repository is a private instance of a Universal Description, Discovery and Integration (UDDI) complaint business registry to which the target enterprise controls access.

10. The method of claim 9, wherein the identifying, quantifying, and adjusting steps are performed in accordance with a programmatic instructions stored within a server, which manages transactions for the target enterprise.

11. The method of claim 8, wherein the previously established programmatic rules are configurable by an authorized administrator of the target enterprise.

12. The method of claim 8, wherein values for the trust level maintained within the private business registry comprise a provisional value and a trusted value, wherein the provisional value is a value assigned to new entities that have yet to conduct business transactions with the target enterprise.

13. The method of claim 8, wherein said steps of claim 8 are performed by at least one machine in accordance with at least one computer program stored in a computer readable media, said computer programming having a plurality of code sections that are executable by the at least one machine.

14. A system for determining a set of seeking entities that are qualified to conduct business transactions on behalf of a target enterprise comprising:
a private instance of a Universal Description, Discovery and Integration (UDDI) complaint business registry to which the target enterprise controls access, said business registry comprising a plurality of registry entries, each associated with a seeking entity, wherein a seeking entity is an entity that desires to conduct business with the target enterprise, wherein each registry entry comprises an attribute for a trust level, which indicates a level of trust existing between the target enterprise and the associated seeking entity, wherein a value of the trust level that a seeking enterprise has within the business registry determines which business opportunities involving the target enterprise that the associated seeking entity is qualified to handle.

15. The system of claim 14, further comprising:
a transaction software engine stored in a computer readable medium and executing upon a computing device, wherein said transaction software engine is configured to manage transaction records for business transactions involving the target enterprise and the seeking entities; and
a trust status software engine stored in a computer readable medium and executing upon a computing device, wherein said trust status software engine is configured to change trust level values of seeking entities stored in the business registry based upon information contained in the transaction records.

16. The system of claim 15, further comprising:
a plurality of configurable rules stored a computer readable medium, wherein the trust status software engine bases determinations of whether to change trust level values upon logic specified in the configurable rules.

17. The system of claim 15, wherein said seeking entities are able to add entries to the business registry using Web Service Description Language (WSDL) based format, wherein a newly added entry is automatically assigned a default trust status value.

18. The system of claim 15, wherein the trust status software engine is configured to increase a trust value of a seeking entity when the seeking entity successfully conducts business transactions with the target enterprise.

19. The system of claim 15, wherein the trust status software engine is configured to decrease a trust value of a seeking entity when the seeking entity unsuccessfully conducts business transactions with the target enterprise.

20. The system of claim 14, further comprising:
a target enterprise computing system configured to solicit a set of seeking entities for a business transaction based upon a level of trust required for the business transaction and a trust level associated with the seeking entities within the business registry.
